(19) United States
(12) Patent Application Publication
(10) Pub. No.: US 2018/0335336 A1
(43) Pub. Date: Nov. 22, 2018

(54) WEIGHING DEVICE

(71) Applicant: Ko Ko Gyi, Caliente, CA (US)

(72) Inventor: Ko Ko Gyi, Caliente, CA (US)

(21) Appl. No.: 15/601,997

(22) Filed: May 22, 2017

(51) Int. Cl. G01G 19/50; G01G 23/36; G01G 19/414

(52) U.S. Cl. CPC G01G 19/50; G01G 19/4146; G01G 23/361

(57) ABSTRACT

A system with a first weighing scale apparatus, wherein said first weighing scale apparatus is configured to measure a body weight when said first weighing scale is facing upward and a second weighing scale apparatus, wherein said second weighing scale apparatus is configured to measure an amount of food when said second weighing scale apparatus is facing upward and said first weighing scale apparatus is facing downward. A platform is configured to perform a weight control function. A user interface of the platform is configured to display and accept information. An action button is configured to indicate whether body or food is to be weighed, and a comment section is configured to display a preset alert notification of a status of said weighing scale device.

### CROSS-REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to weighing devices. More particularly, certain embodiments of the invention relates to a portable dual function scale that may be used as part of a weight control system.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Many individuals may wish to monitor their body weight and food intake for weight control purposes. It is believed that the amount of food eaten may have more impact on weight than the types of food eaten. Therefore, the avoidance of overeating may be particularly important for weight control. Individuals wishing to control their weight may also monitor their body weight regularly. It is believed that weighing one's self every two to three hours may help make body weight correction easier and more effective by typically decreasing wild body weight swings. Present day personal scales are typically designed for use in a home and may be of a size that is inconvenient to transport from place to place to allow for weight monitoring when away from home.

By way of educational background, another aspect of the related technology generally useful to be aware of is that currently there are a number of weight loss programs and diet plans. Many of these programs are membership based where the price for membership is not trivial. These programs may involve counseling, body weight monitoring, entering body weight online, etc. Some programs may require members to purchase meals for consumption on a scheduled basis. It is believed that there may be limited choices for these meal plans and that there may be little consideration of the member's preference on the type of meal they would like to eat.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate an exemplary portable body weight control system with a dual function scale, in accordance with an embodiment of the present invention. FIG. 1A is a diagrammatic top view of the weight control system, and FIG. 1B represents an exemplary user interface for the weight control system;

FIGS. 2A, 2B, 2C, and 2D illustrate an exemplary portable dual function scale, in accordance with an embodiment of the present invention. FIG. 2A is a top perspective view of the dual function scale. FIG. 2B is a bottom perspective view of the dual function scale. FIG. 2C is a top perspective view of the scale with stabilizers, if deemed necessary as an option for stability but not limited to and FIG. 2D is a partially cut away side view of the scale;

FIGS. 3A and 3B illustrate an exemplary dual function scale, in accordance with an embodiment of the present invention. FIG. 3A is a top perspective view of the internal construction of a body weighing side of the scale, and FIG. 3B is a cross sectional side view of the scale;

FIGS. 4A and 4B illustrate an exemplary dual function scale, in accordance with an embodiment of the present invention. FIG. 4A is a partially cut away top perspective view, and FIG. 4B is a partially cut away diagrammatic side view; and

FIG. 5 is a block diagram illustrating an exemplary dual function scale system, in accordance with an embodiment of the present invention;

FIGS. 6A through 6C illustrate an exemplary dual function scale with body weight load cells and food weight load cells mounted on the same side of a base, in accordance with an embodiment of the present invention. FIG. 6A is a bottom perspective view of the base. FIG. 6B is a front perspective view of the base with the bottom facing upward in a configuration for measuring body weight, and FIG. 6C is a front perspective view of the base with the bottom facing upward in a configuration for measuring food weight;

FIGS. 7A through 7C illustrate an exemplary scale with a single weighing plate, in accordance with an embodiment of the present invention. FIG. 7A is a bottom perspective view of the weighing plate. FIG. 7B is a front perspective view of a unit base in a configuration to weigh food, and partially cut away front perspective view of the unit base that exemplifies the arrangement of the body load cell and the food load cells. FIG. 7C is a front perspective view of a unit base in a configuration to measure body weight;

FIG. 8 is a block diagram illustrating exemplary interactions between components of a weight control application, in accordance with an embodiment of the present invention;

FIGS. 9A through 911 illustrate exemplary screen shots from an Android device running an application for use with a weight control system, in accordance with an embodiment of the present invention. FIG. 9A shows an exemplary welcome page.

FIG. 9B shows an exemplary plan creation page. FIG. 9C shows an exemplary status page. FIG. 9D shows another exemplary status page. FIG. 9E shows an exemplary food selection page. FIG. 9F shows an exemplary food weighing page. FIG. 9G shows an exemplary workout selection page, and FIG. 911 shows an exemplary workout input page; and

FIGS. 10A through 10F illustrate exemplary screen shots from an IOS® device running an application for use with a weight control system, in accordance with an embodiment of the present invention. FIG. 10A shows an exemplary welcome page. FIG. 10B shows an exemplary client registration page. FIG. 10C shows an exemplary plan creation page. FIG. 10D shows an exemplary goal setting page. FIG. 10E shows an exemplary plan record in a tabular format, and FIG. 10F shows an exemplary plan record in a graphical format.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearward most point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to avoid a strict numerical boundary to the specified parameter,” see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived there from.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, are generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of, or interaction with, some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions shape or form factor or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention may provide a portable dual function scale. This scale may be used as part of a personal body weight control system. In some embodiments the scale may comprise a load sensing unit packaged with associated electronics in a compact housing. In addition, in some embodiments the scale may be connected to a mobile platform device by means of a USB cable, a Bluetooth wireless connection, etc. Application software installed on the mobile platform device may perform functions relating to the process of body weight control such as, but not limited to, displaying body weight and food weight, calculating the amount of food that should be consumed, allowing a user to enter information, etc. Some embodiments of the present invention may provide a user with a means of controlling routine food consumption in order to help achieve a target weight as planned.

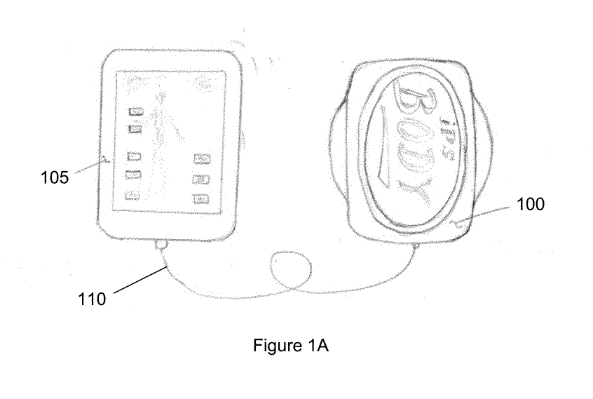

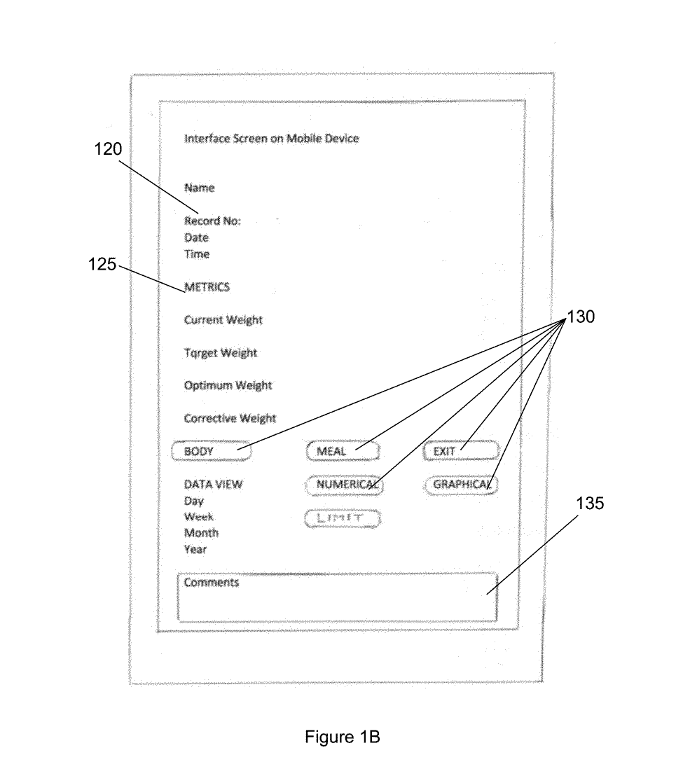

FIGS. 1A and 1B illustrate an exemplary portable body and food weight control system with a dual function scale 100, in accordance with an embodiment of the present invention. FIG. 1A is a diagrammatic top view of the weight control system, and FIG. 1B represents an exemplary user interface for the weight control system. Referring to FIG. 1A, in the present embodiment, the weight control system may enable a user to make accurate readings of body weight and food weight on a single portable scale 100. Scale 100 comprises a dual weighing mechanism that enables a user to measure body weight on one face of scale 100 and food weight on the flipside of scale 100. Scale 100 may be connected to a mobile platform device 105 via a USB cable 110 as an option. In some embodiments the scale may connect to the mobile platform device through a wireless connection such as, but not limited to Wi-Fi or Bluetooth®. Mobile platform device 105 may also be able to connect through the Internet or wireless connection to a database or cloud to obtain and/or store information pertaining to the weight control system. It is contemplated that a multiplicity of suitable devices may be used for mobile platform device including, without limitation, smart phones, tablet computers, smart watches, laptop computers, etc. It is further contemplated that in some applications a user may connect the scale to a stationary platform device such as, but not limited to, a desktop computer or a high-level game console. Once dual function scale 100 is connected to platform device 105, a user may follow an initial setup procedure to prepare the system for use. The initial system setup procedure may comprise various different steps including, but not limited to, downloading application software, installing and running an accompanying program on platform device 105, entering personal information and weight preference based upon height, body weight, target body weight, date to achieve goal, and other pertinent information. The system may be password protected as an option to help ensure the privacy of the user. Some embodiments may allow for multiple users to use the system. In these embodiments, each user account may be associated with a unique password for individual privacy. After initial setup, the user may employ the system to perform weight control functions.

In typical use of the present embodiment, a user may place dual function scale 100 on the clean level floor with the side marked BODY facing up in full view. Scale 100 may be provided with a soft flexible bag that may be placed around scale 100 during body weighing to help keep scale 100 in a sanitary condition at all time ready for use in measuring food weight during meal time. The user may then turn on platform device 105 or press a start button, and the system may go through a zeroing process of scale 100. After the zeroing process, the system may give an indication such as, but not limited to, a beep, a verbal command, or flashing lights to signal that the weighing process can begin. At this point, the user typically stands on the floor with one foot near scale 100 and the ball of the other foot on scale 100. When the system indicates that the weighing process may begin, the user can slowly transfer all of his body weight onto the foot on scale 100 and slowly raise the other foot off of the floor. The foot not on scale 100 does not need to be far off the floor, for example, without limitation, the foot may not need to be more than one inch above the floor; what is typically required is that the foot does not touch any object. The user may place scale 100 within close proximity to a wall, a fixture fastened to the wall, or a piece of furniture as a means to maintain balance if needed during weighing on one foot. Once the weight is obtained, the system may again indicate to the user that the weighing process is finished with a beep or another type of indication, and the user may dismount scale 100. Referring to FIG. 1B, the user interface on mobile platform device 105 may display and/or accept general information 120 such as, but not limited to account name, date, and time as well as system metrics 125 including, but not limited to, current body weight, target weight, target date optimum weight, and other pertinent data. Once the system processes incoming weight data, the body weight data is automatically logged in without the user's intervention. The user interface may then display pertinent information and any actions that should be performed by the user such as, but not limited to, pulling up various screen displays showing metabolic activity, especially for new clients, displaying body weight tracking graphically on a variety of time line intervals, displaying food consumptions and over consumption, suggesting possible workouts the user may perform, etc. Furthermore, various action buttons 130 on the user interface may enable the user to indicate if he is weighing his body or food, switch between a numerical and graphical display of the data, exit the system, etc. The user interface may also comprise a comments section 135 in which the user may enter comments or notes. Comments section 135 may also be used to input or display information when the user requests certain client support function from the client membership entity. In addition, comments section 135 may also be used to display alerts, warnings, or notifications regarding the status of the dual function scale 100. For user privacy protection, when prompted, the user may enter a name and a password on the user interface of the mobile platform device 105, before the user can access any of the stored records. Those skilled in the art will readily recognize, in light of and in accordance with the teachings of the present invention, that user interfaces in alternate embodiments may display various different types of information in a multiplicity of suitable layouts and services. For example, without limitation, some embodiments may display starting weight, daily and weekly goals, weight control tips, inspirational messages, etc. These display configurations may be pre-programmed within the application software and/or client membership entity. In some embodiments the system may facilitate an alert to the user for a scheduled body weight reading session to help prevent missed body weight reading sessions, especially during a hectic course of the day.

At meal or snack time, dual function scale 100 may also be used to weigh the amount of food being consumed. In typical use of the present embodiment, scale 100 may be placed on a table with the FOOD side up. The user may place the food to be eaten including the plate on top of scale 100 and utilize the camera from platform device to snap an image of the food to inform the system what type of food is being eaten. Manual input of the meal components may be used by entering a food code on platform device 105 in some applications as an alternative to photographing the food serving and comparing with images on file. Other methods of food identification may include without limitation the use of mass spectrometer and image recognition analysis to identify the ingredients of the food to determine the caloric content. The system may have access to several databases resident in platform device 105 or in the cloud or Internet to analyze the fat content and calorie count of the meal. The system may also use these databases to determine the appropriate serving size by weight to accomplish the weight control goals of the user. The total weight of the food including the plate and the weight of food for consumption may be displayed on the user interface of platform device 105. It is typically not necessary to zero out the weight of the plate before food is weighed on scale 100. When the user sets a food laden plate on scale 100 and presses a MEAL button, the total weight is logged into the memory of platform device 105. Platform device 105 may display the total weight of the food and plate combined and the consumable limit weight. As the user eats, the system continually scans the weight on scale 100 at several times a second to keep track of the amount of food consumed. When the allowable amount of food is eaten assuming the user ate the food, the system may indicate to the user by a beep, an alarm, or other indicator that the limit has been reached and to stop eating. If the user continues to eat the food, a display of the over-consumption of food appears on the user interface. This over-consumption may then be taken into account in the determination of the next allowable meal limit. Since the system continually monitors the amount of food consumed, the food may be placed on almost any type of serving ware including, without limitation, plates, bowls, and/or cups without the need for zeroing out the empty serving ware. In another mode of using the food weighing side of scale 100, a user may eat the food at his discretion after the weight of the food is obtained. At the end of the meal or snack, the user may indicate to the system that he is done eating, for example, without limitation, by tapping a “Meal End” or similar button on the user interface. The system may then display the amount of food consumed and log this information. Prompts can be set to inform the user as to the amount of food that has been consumed outside of the allowable amount. In the present embodiment, the pertinent data including, without limitation, body weight, target weight, target date, food weight, date, time of the day, etc. may be automatically logged into the memory of platform device 105. Therefore, there is typically no human intervention that may corrupt the data or cause inaccuracies. All saved information may be recalled at any time together with the analyzed data for meal and weight control effectiveness, and further recommendations or adjustments to the weight control program may be displayed. Therefore helping to optimize the weight control for the user. Typically, a password may be needed to recall this information so that the information pertaining to the user in the system may remain personal and private. The output of these data can be in the form of graphs and/or charts or numerical data depending on the preference of the user.

In typical use of the present embodiment, a user may weigh himself every two to three hours to determine the metabolic activity of the body and physical system. It is believed that this may make body weight correction easier with accuracy and more effective than when taking measurements only once or twice a day and may reduce wild body weight swings. Since dual function scale 100 may be about the size of a smart phone, scale 100 typically may be carried in a pocket or purse together with mobile platform device 105. Unlike a conventional bathroom scale, where one would weigh one's self in the morning before going off to work and maybe weigh one's self again in the evening, scale 100 may be easily carried by the user for use practically anytime and anywhere as necessary. Some embodiments may enable a user to augment the target weight loss achieved by performing workouts during the course of the program. In such embodiments the user may enter a workout code into the mobile platform device, and the system is prompted to process the information. The system may use this information to adjust parameters such as, but not limited to, consumable food amount or time to achieve target weight goal at the discretion of the user.

An aspect of the present embodiment may be to provide an affordable weight control system by eliminating duplicity of the display and data processing electronic hardware. The system may utilize the computational power and sophistication of platform device 105 as well as the display of platform device 105, which may eliminate the need for a dedicated readout on dual function scale 100. The data storage, memory, and other related hardware of platform device 105 may also be used rather than creating dedicated hardware and memory for the system. This typically reduces the cost to manufacture scale 100 while maintaining capability and sophistication in the system. In addition, the dual function of scale 100 typically means the user only needs to buy one scale rather than two. In the present embodiment, the system is user friendly, simple to setup, and easy to operate for individuals who already own a mobile platform device such as, but not limited to, a smartphone or tablet computer. In addition, the weight control system may be preferred by individuals with different cultural habits and food preferences since they may eat practically any type of food using this system.

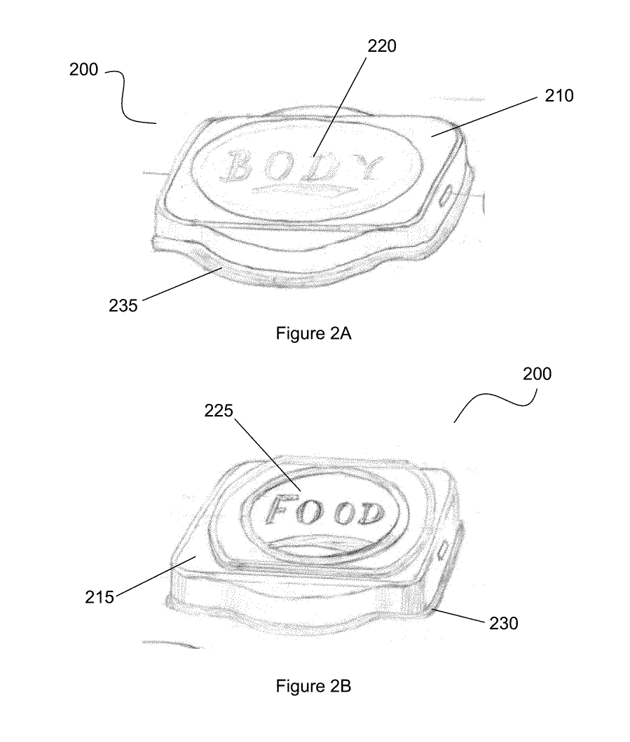

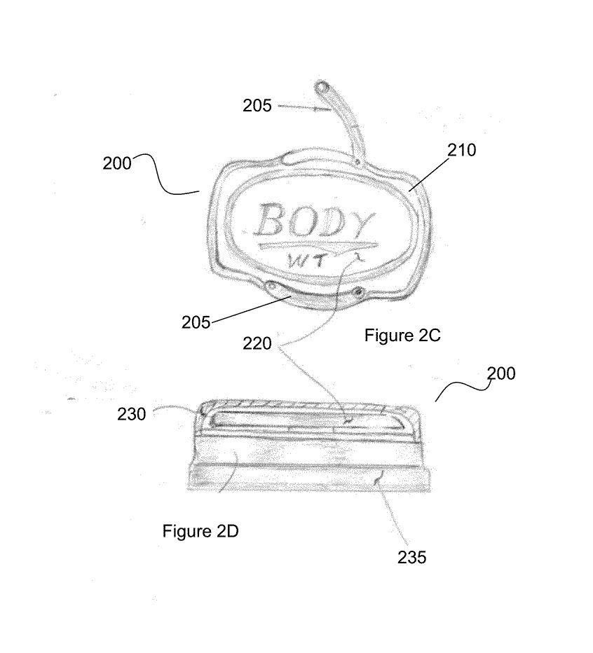

FIGS. 2A, 2B, 2C, and 2D illustrate an exemplary portable dual function scale 200, in accordance with an embodiment of the present invention. FIG. 2A is a top perspective view of dual function scale 200. FIG. 2B is a bottom/opposite perspective view of dual function scale 200. FIG. 2C is a top perspective view of portable dual function scale 200 with stabilizers 205, and FIG. 2D is a partially cut away side view of portable dual function scale 200. In the present embodiment a top face 210 of scale 200 is marked BODY or Body Wt, and a bottom face 215 is marked FOOD or Food Wt so as not to confuse between the two weighing scales. Referring to FIGS. 2A, 2C, and 2D, top face 210 comprises a foot step plate 220 that engages a weighing mechanism within scale 200 to measure body weight when a user stands on scale 200. In some instances, the user may extend one or both stabilizers 205 to help prevent rocking of scale 200 when standing on it. It is contemplated that stabilizers may be optional, and some embodiments may be implemented without stabilizers. Alternate embodiments may comprise suction cups on the covers to help secure the scale to a smooth surface when standing on the scale or when placing food on the scale. Referring to FIG. 2B, in the present embodiment, bottom face 215 comprises a weighing tray 225 that also engages a weighing mechanism within scale 200 to weigh food placed on tray 225 when facing upward and the top face 210 facing downward. Referring to FIG. 2D, a top cover 230 and a bottom cover 235 may be placed over step plate 220 and tray 225, respectively. Covers 230 and 235 may be structured to hold at least 300 pounds to safeguard load sensitive step plate 220 and weighing tray 225 when not in use. A port 240 may also be included on scale 200 that may be used to connect scale 200 to a platform device or to charge the batteries in scale 200. Those skilled in the art will readily recognize, in light of and in accordance with the teachings of the present invention, that weigh scales in some alternate embodiments may be implemented in a multiplicity of suitable shapes. For example, without limitation, some embodiments may be circular, rectangular, square, or other fancy configurations in shape. In addition, the size of scales in some embodiments may vary while still maintaining compactness, portability and accuracy.

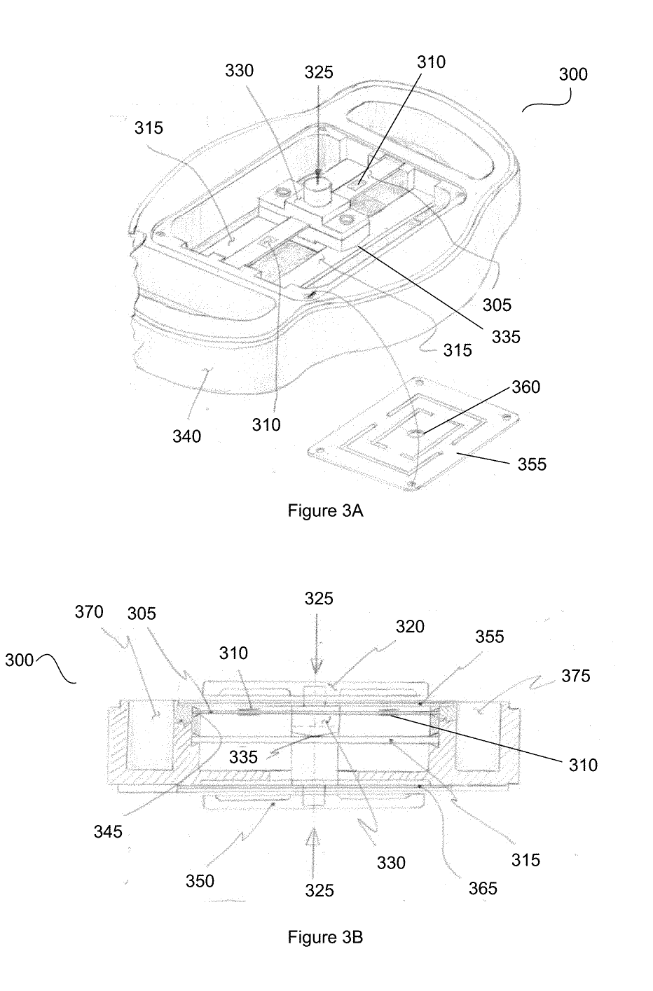

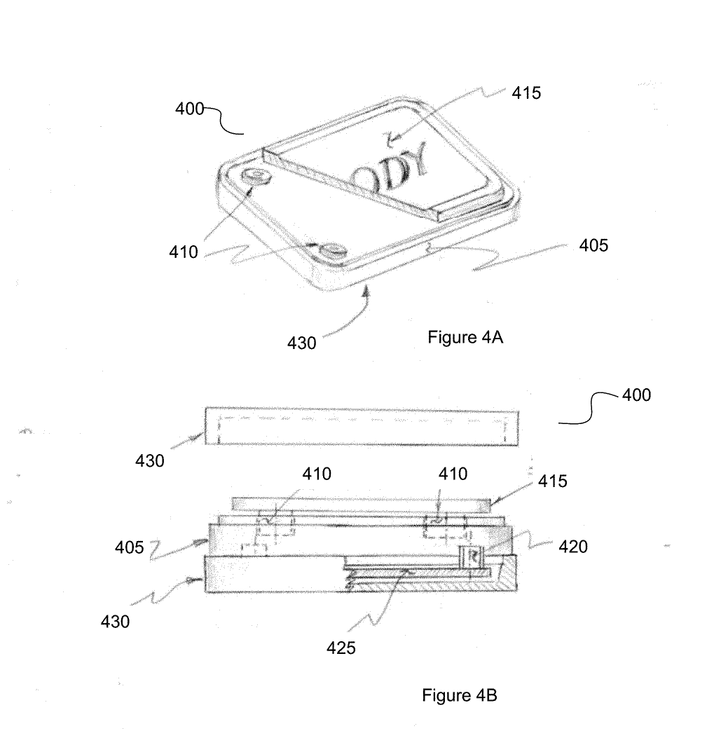

FIGS. 3A and 3B illustrate an exemplary dual function scale 300, in accordance with an embodiment of the present invention. FIG. 3A is a top perspective view of the internal construction of a body weighing side of scale 300, and FIG. 3B is a cross sectional side view of scale 300. In the present embodiment, a load sensitive beam 305 may have a length, width and thickness appropriately sized to provide the necessary sensitivity and accuracy for the range of food scale 300 may be intended to measure. Beam 305 may be mounted with multiple sensors 310 and may be utilized for making both body and food weight measurements. Sensors 310 may be mounted to the top and/or bottom surface of load sensitive beam 305. It is contemplated that various different types of sensors may be used for this weight measurement including, without limitation, strain gauges, piezoelectric sensors, pressure sensors, and capacitive sensors.

When measuring objects on the body side of dual function scale 300, load sensitive beam 305 may work in conjunction with two body weight support beams 315, which may help support the weight of the object. In this mode, scale 300 is positioned with a foot step plate 320, which may be labeled with a marking such as, but not limited to, BODY or Body Wt, facing upward. In this position weight support beams 315 are below the instrumented load sensitive beam 305 to provide support. Foot step plate 320, which may be attached to a central shaft 325, may transfer the weight of the object onto load sensitive beam 305 through a connected loading beam 330. In response to the weight load, sensors 310 such as, but not limited to strain gauges, may produce a differential electrical voltage based on the amount of strain on the surfaces of load sensitive beam 305 which is processed electronically to determine the weight of the load for display on a connected platform device. When scale 300 is positioned for body weight weighing, loading beam 330 is typically in contact with the surfaces of body weight support beams 315 along an edge 335 on the bottom surface of loading beam 330. The pointed shape of the contact point at edge 335 and support beams 315 typically provides a precise loading point on support beams 315 to obtain accuracy and repeatability in the measurement of the body weight. In some embodiments, the scale may be implemented without pointed contact points. Body weight support beams 315 may be spaced apart to help prevent foot step plate 320 from rocking when weight is applied to foot step plate. With the application of a load on foot step plate 320, load sensitive beam 305 and body weight support beams 315 all deflect as a composite by the same amount. Body weight support beams 315 typically limit the total deflection of load sensitive beam 305 for maximum loads when measuring body weight. In the present embodiment, the maximum food weight is approximately 10 pounds, and the maximum body weight is approximately 300 pounds. The active beam length and the cross-sectional dimensions of load sensitive beam 305 and support beams 315 may be configured to obtain the same maximum deflection when scale 300 is loaded to the maximum food weight and the maximum body weight. In some embodiments, a notification on the user interface of the mobile platform device 105 and/or dual function scale 300 may indicate, but not limited to, scale dual function 300 is loaded at/or over the maximum body weight or food weight. Additionally, a notification may indicate that a preset or preferred body weight or food weight has been reached. It is contemplated that the size and configuration of beams 305 and 315 can be changed in different ways to suit the application. Load sensitive beam 305 may be in contact with a base 340 of scale 300 along knife edge supports 345.

Referring to FIG. 3B, dual function scale 300 may be flipped over for weighing food so that a food weighing tray 350, which may be labeled with a marking such as, but not limited to, FOOD or Food Wt, is facing upward. In this position, body weight support beams 315 are positioned above loading beam 330. Therefore, application of a load on food weighing tray 350 typically only deflects load sensitive beam 305 and does not affect body weight support beams 315. In some embodiments, the body weighing scale may operate independently from the food weighing scale. In additional embodiments, a notification on the user interface of the mobile platform device 105 and/or dual function scale 300 may indicate, but not limited to, a measured weight is proximate close to a preset and preferred food or body weight. Additionally, a notification may indicate that a preset or preferred food weight has been reached. A notification may include but not limited to, alerts, warnings, blinking LEDs, buzzers, sound, etc. In other embodiments, power supplying the electronics of the weighing scale when facing downward may be manually or automatically turned off. So that only the electronics of the weighing scale facing upward is turned on. The sensors 310 and/or loading beam 330 may provide an indication of an orientation of the dual function scale 300.

In the present embodiment a gimbal flexure 355 may mount to base 340, fastened by four screws or other attachment means. A center hole 360 of gimbal flexure 355 may slide onto central shaft 325 and may also be fastened to the top surface of loading beam 330 by various different attachment means such as, but no limited to, screws, pins, adhesive, welding, etc. Center hole 360 slips on to central shaft 325 and a socket in foot step plate 320 may be pressed onto central shaft 325 sandwiching gimbal flexure 355. A second gimbal flexure 365 may be similarly attached to the food weighing side of scale 300. This arrangement typically allows for free movement of foot step plate 320 and food weighting tray 350 in the directions to bend load sensitive beam 305, and body weight support beams 315 in the case of foot step plate 320, with minimal friction axially while typically maintaining stiffness in the lateral direction of the springs of gimbal flexure 355.

In typical use of the present embodiment, load sensitive beam 305 measures weight in the food range, which may be 0 to 10 pounds+/−0.3 pounds. Thus, to convert a body weight measurement from the food range into the body weight range, which may be 0 to 300 pounds+/−0.5 pounds, the measurement is multiplied by a scale factor. The scale factor may be determined by first applying a 10-pound load to the food weight measuring side of scale 300 and measuring the deflection of food weighing tray 350. Then, with the body weight measuring side up, a load may be applied to foot step plate 320 and the applied load is increased until the deflection of foot step plate 320 equals the deflection of food weighing tray 350 for the 10-pound load. The weight of this load divided by 10 pounds is the scale factor. For example, without limitation, if a 10-pound load causes food weighing tray 350 to deflect X inches, and it takes a 250-pound load to deflect foot step plate 320 by the same X inches, the scale factor would equal 250 divided by 10, which is a scale factor of 25. This scale factor may be applied in the software to automatically display the correct body weight of the user. Weighing the quantity of food for consumption on foot step plate 320 typically would not give an accurate reading since the sensitivity of scale 300 at the bottom range may be low while the beam hysteresis is large. Therefore, the present embodiment provides two scales in one utilizing two different beam configurations giving two different sensitivities and measuring ranges. Overload load prevention stops are inherently designed into the system by limiting the operating clearance provided to match the foot step plate 220 movement for maximum weight within the cavity of the cover plate 230 in FIG. 2D. Similarly the food weighing scale is equipped with overload stop. (this preceding verbiage may be moot, as it is covered later paragraph) A notification may be indicated, but not limited to, a suggestion to use the food weighing scale instead of using the body weighing scale to get a better reading. Additionally, a notification may indicate that a preset preferred food weight has been reached. The dual range weighing scale in some embodiments can be configured for various other applications with two scales having different ranges back to back, side by side or stacked top and bottom.

In the present embodiment the various components used to build and use dual function scale 300 are typically designed to withstand a body weight in excess of 300 pounds without the need for massive structural components. Since the physical size of scale 300 is relatively small, the component stiffness to mass ratio of the components increases significantly as compared to a long beam would require heavier cross-sections for the same stiffness. Also, the compactness of scale 300 allows for portability. In the present embodiment, base 340 is typically the only component that requires rigidity. Moreover, the food scale can be designed to be built with light weight components to provide a balanced structural rigidity, sensitivity and accuracy. In many instances, component shapes can be varied to minimize inherent characteristic of the material such as, but not limited to, hysteresis and set recovery.

In the present embodiment, base 340 may comprise an electronics compartment 370 and a battery compartment 375. The electronics within dual function scale 300 may involve sensors 310 and an amplifier that may detect the differential voltage from load sensitive beam 305 and amplify this voltage to the required voltage level. In addition, an analog to digital converter may be included to convert the analog voltage into a digital signal, and Bluetooth® wireless circuitry may be included to communicate with a mobile platform device. The amplifier, converter and Bluetooth wireless circuitry may be attached to an electronics board mounted in electronics compartment 370. Calibration circuitry and application software may be installed on a connected platform device to display the readings from scale 300 without the need for a dedicated readout device on scale 300. This may enable the size of the electronic components board to be reduced. The power supply for scale 300 may comprise multiple button batteries packaged inside battery compartment 375. Alternatively, rechargeable lithium batteries or other types of batteries may be used as the power source in some embodiments. Some embodiments may also comprise a USB port in the base which may be used to connect to a platform device or to charge rechargeable batteries. It is contemplated that other types of ports for the input and export of power and information may be provided in some embodiments such as, but not limited to, mini and micro USB ports, HDMI or DC connector ports. In the present embodiment, covers (not shown) may also be provided to protect foot step plate 320 and food weighing tray 350 when not in use. In typical use, the cover for foot step plate 320 is in cover position while dual function scale 300 is in the food weighing mode and the cover for food weighing tray 350 is in position while dual function scale 300 is in the body weighing mode. The covers may serve as a pillow block below dual function scale 300 providing space for free movement of foot step plate 320 and food weighing tray 350 and may limit axial movement of foot step plate 320 and food weighing tray 350 to protect load sensitive beam 305 from going over the stress limit.

FIGS. 4A and 4B illustrate an exemplary dual function scale 400, in accordance with an embodiment of the present invention. FIG. 4A is a partially cut away top perspective view, and FIG. 4B is a partially cut away diagrammatic side view. In the present embodiment, scale 400 comprises two sets of four load cells mounted back to back on a base plate 405 in a rectangular pattern near the corners. Body weight load cells 410 may be mounted between base plate 405 and a foot step plate 415 to form a load measuring surface. On the flip side, a similar arrangement of mounting food weight load cells 420 of higher sensitivity to measure lower weight may be mounted between base plate 405 and a food weighing tray 425. It is contemplated that separate electronics circuitry may be used for each set of load cells for simplicity when dealing with the different ranges of measurements. For example, without limitation, body weight load cells 410 may be configured to measure a weight range from 0 to 300 pounds, and food weight load cells 420 may be configured to measure a weight range from 0 to 10 pounds. Thus, a scale factor as used in the foregoing embodiment is typically not required for the present embodiment. It is contemplated that some embodiments may be configured to measure different ranges of weights. Furthermore, some embodiments may be implemented with more or fewer load cells in various different configurations. For example, without limitation, one alternate embodiment may comprise a single load cell in the center of the foot step plate to measure body weight and a single load cell in the center of the food weighing tray to measure food weight. In the present embodiment, the output of the load cells being used at the time may be processed by a connected mobile device and displayed on its screen. Foot step plate 415 and food weighing tray 425 may be protected by means of two covers 430. In typical use of the present embodiment, the cover 430 of the side of scale 400 not in use must be in position to help ensure that scale 400 is not sitting on the load measuring surface not in use.

In the foregoing embodiments, cylindrical load cells with load plungers are shown for simplicity. Load cells using flexible cantilevers as the sensitive elements for measuring the weight load on either the foot step plate or on the food tray and or both can be utilized. The systems use dual weight ranges since the scale in body weighing mode may not have the sensitivity to respond to a light weight, for example, without limitation, a weight of less than 10 pounds, due to the structural stiffness, hysteresis and set recovery of the beams. Furthermore, load cells utilizing the measurement of strain from bending beams or compressive or tensile deformation of load cell structures could be utilized for weight measurement devices depending upon the range of weight the instrument is designed to measure to obtain the sensitivity desired.

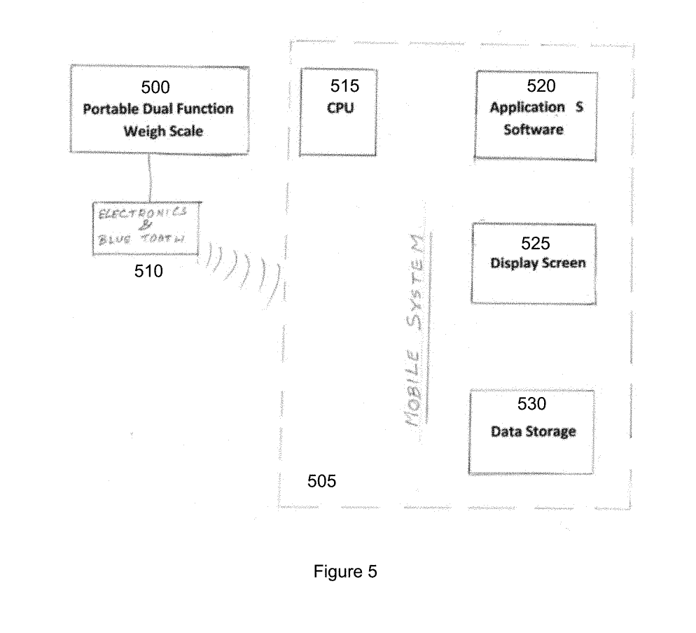

FIG. 5 is a block diagram illustrating an exemplary dual function scale system, in accordance with an embodiment of the present invention. In the present embodiment, a dual function scale 500 may connect to a mobile device system 505 through a Bluetooth® connection 510 or another type of wireless connection. In some embodiments this connection may be a physical connection such as, but not limited to, a USB cable. The system only requires one type of connecting means for dual function scale 500 to communicate with mobile device system 505, yet some embodiments may comprise multiple types of connecting means. In the present embodiment, mobile device system may comprise a CPU 515, application software 520, a display screen 525, and data storage 530. It is contemplated that the mobile devices in some alternate embodiments may comprise additional functionalities that may be used by the dual function scale system such as, but not limited to, cameras, internet access, remote access, etc. For example, the mobile device may be used to communicate the records stored in the dual function scale 500 to the internet or remote advisor, such as, but not limited to a dietitian, doctor, friend or family.

In the present embodiment, a variety of application software options may be offered depending upon the sophistication level desired by the user. For example, without limitation, entry level application software may measure and display the basic weight, date, and time and may allow for data logging capability for a single user. As an upgrade, some application software may allow for multiple users to log data with password protection to maintain privacy for each user. A further upgrade may involve a complete meal setup with entrée and sides selection that may determine and display an appropriate serving size of the complete meal, which the user may then prepare and weigh on the food scale before eating. At the completion of the weighing, all of the information may be logged into the system for body weight and future analysis and reference on which meals work and which do not work. This system may also log user preferences and favorites. Another application software upgrade may take into account a monthly food budget with constraints on eating out and eating home prepared food to control food expenditures, weight, and budget constraints. Application software may be developed to run on various different operating systems such as, but not limited to, Android™ platform, Apple OS platforms, Windows® operating system platforms, etc.

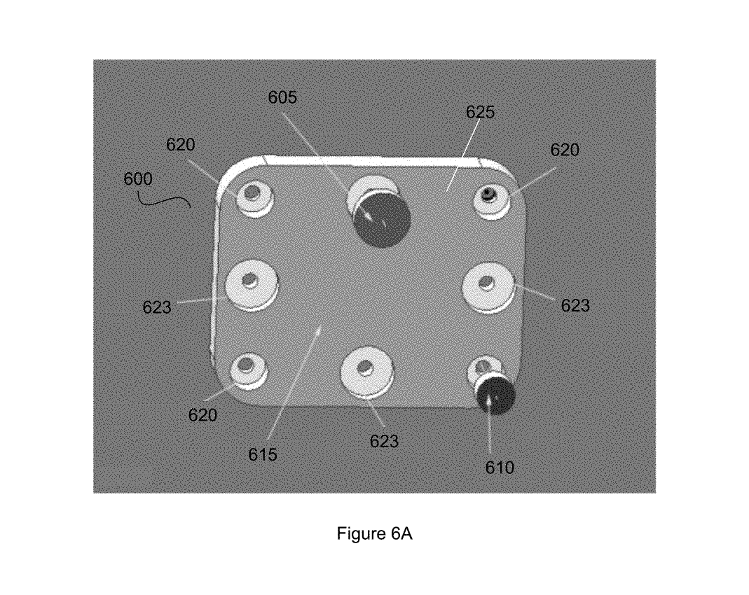

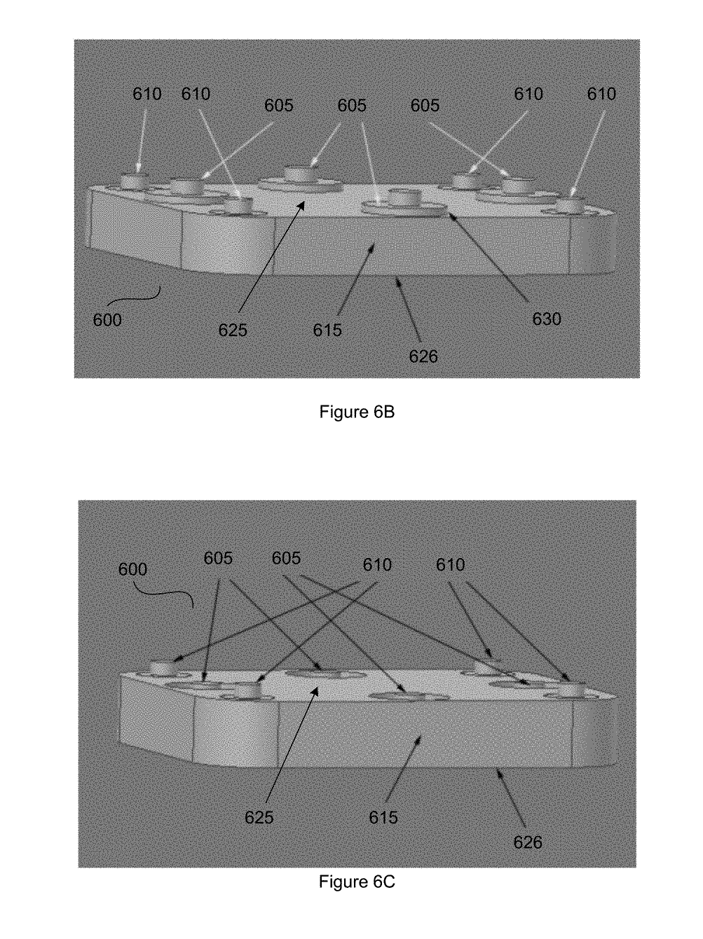

FIGS. 6A through 6C illustrate an exemplary dual function scale 600 with body weight load cells 605 and food weight load cells 610 mounted on the same side of a base 615, in accordance with an embodiment of the present invention. FIG. 6A is a bottom perspective view of base 615. FIG. 6B is a perspective view of base 615 with the bottom facing upward in a configuration for measuring body weight, and FIG. 6C is a t perspective view of base 615 with the bottom facing upward in a configuration for measuring food weight. In the present embodiment, scale 600 comprises four body weight load cells 605 and four food weight load cells 610. Food weight load cells 610 may be mounted in food load cell pockets 620 near the corners of unit base 615 and are typically on the same mounting plane in order that the four surfaces of food weight load cells 610 that come into contact with the floor surface or any horizontal surface are also coplanar. This assumes that the physical lengths of food weight load cells 610 are all the same. Referring to FIG. 6C, to measure food weight, the four floor contacting surfaces of body weight load cells 605 may be retracted axially away from the floor surface into body load cell pockets 623 to enable only the contacting surfaces of food weight load cells 610 to come into contact with the floor surface. The distance by which to retract body weight load cells 605 can be determined by the deflection under maximum load of a relatively small weight such as, but not limited to, 10 lbs. measured on a bottom surface 625 of unit base 615 where load cells 605 and 610 are mounted. The flat top surface 626 as shown in FIGS. 6B and 6C acts as the common weight loading plate to measure both food and body weight. The scale 600 positioned to measure food weight, that is with the surface 626 at the top and surfaces 605 and 610 at the bottom, When scale 600 is loaded at and beyond the maximum food weight deflection, body weight load cells 605 may come into contact with the floor surface which would give an erroneous reading in this embodiment, an additional clearance is provided in order to prevent all eight load cells 605 and 610 from touching the floor surface. An erroneous reading will be flagged by the mobile device as an error.

Referring to FIG. 6B, in the present embodiment, the four surfaces of body weight load cells 605 that contact the floor surface when in use are constrained to be co-planar at two set locations relative to the surface 625 to select body weight measurement or food weight measurement. This movement of the four body weight load cells 605 to the two set locations means that all four of body weight load cells 605 are typically actuated by means of a slideable wedge, lead screw or cam mechanism and a lever or push button interconnected to slide all four load cells 605 axially in a simultaneous manner within the guides of base 615. Such a mechanism may enable the floor contacting surfaces of body weight load cells 605 to have the capability to extend a set distance 630 to enable maximum body weight measurement and a clearance beyond the floor contacting surfaces of food weight load cells 610. The drawings do not show the actuating mechanism or the cavity in base 615 that may be included to house any electronic components.

In the present embodiment, the foot step plate and the food weighing tray is a common weighing plate 626 on which food weight and body weight may be measured. This typically eliminates the need for two weighing plates as illustrated in some of the foregoing embodiments.

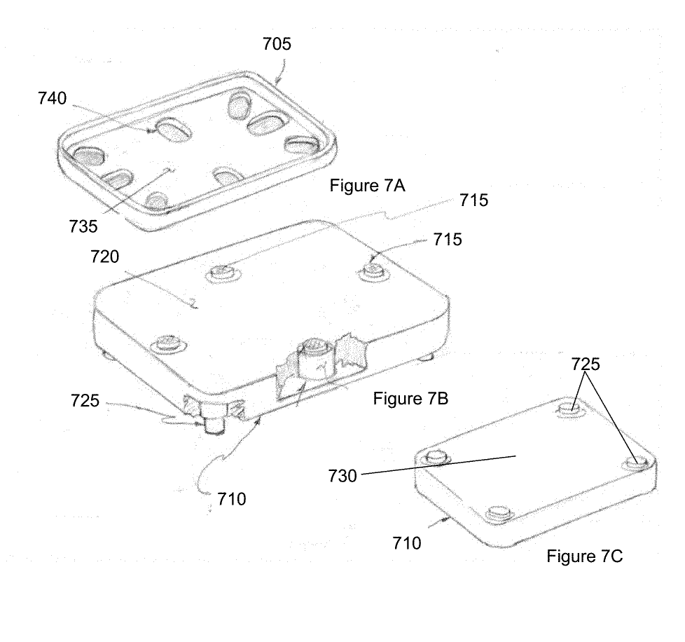

FIGS. 7A through 7C illustrate an exemplary scale with a single weighing plate 705, in accordance with an embodiment of the present invention. FIG. 7A is a bottom perspective view of weighing plate 705. FIG. 7B is a partially cut away front perspective view of a unit base 710 in a configuration to weigh food, and FIG. 7C is a front perspective view of unit base 710 in a configuration to measure body weight. In the present embodiment, base 710 comprises body weight load cells 715 protruding from a food weighing surface 720, and food weight load cells 725 protruding from an opposing body weighing surface 730. Body weight load cells contact surfaces 715 are protruding at it's maximum from food weighing surface 720 At maximum load the surface of body weight load cells 715 and food weighing surface, both of which would be in contact with the floor, become co-planer. This can help prevent body weight load cells 715 from being overstressed.

Referring to FIG. 7A, weighing plate 705 comprises an inner surface 735 with recessed slots 740 that correspond to the positions of load cells 715 and 725. In use inner surface 735 of weighing plate 705 is in contact with food weighing surface 720 or body weighing surface 730 depending on how base 710 is positioned. For example, without limitation, if the scale is being used to weigh food, base 710 is positioned with food weighing surface 720 facing upward and food weight load cells 725 in contact with the floor or other horizontal surface, as illustrated by way of example in FIG. 7B. Weighing plate 705 is then placed on top of food weighing surface 720 so that body weight load cells 715 extend into recessed slots 740 on inner surface 735. This typically enables inner surface 735 to be in contact with food weighing surface 720 while body weight load cells 715 are not activated. Weighing plate 705 may be used similarly on body weighing surface 730 to weigh body weight when base 710 is positioned with body weighing surface facing upward, as illustrated by way of example in FIG. 7C. The use of a single weighing plate 705 may allow for the overall height of the unit to be smaller and also decreases the number of parts in the unit.

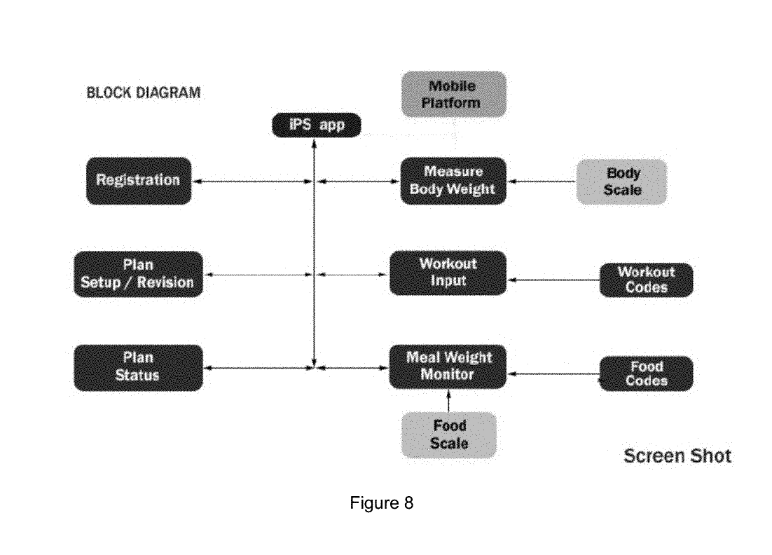

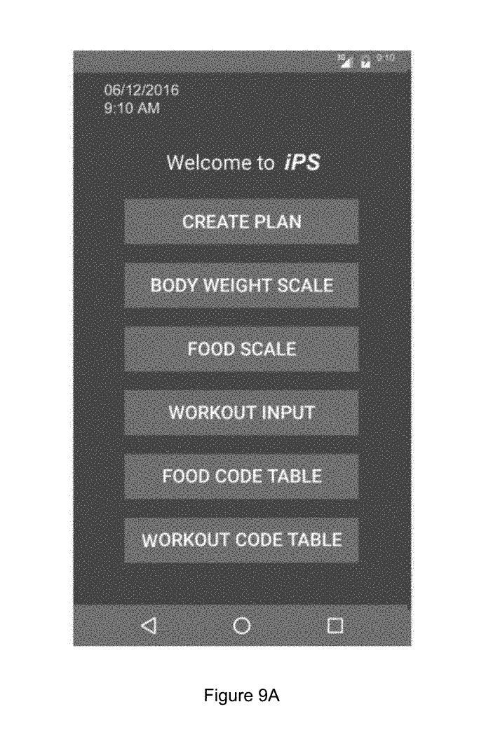

FIG. 8 is a block diagram illustrating exemplary interactions between components of a weight control application, in accordance with an embodiment of the present invention.

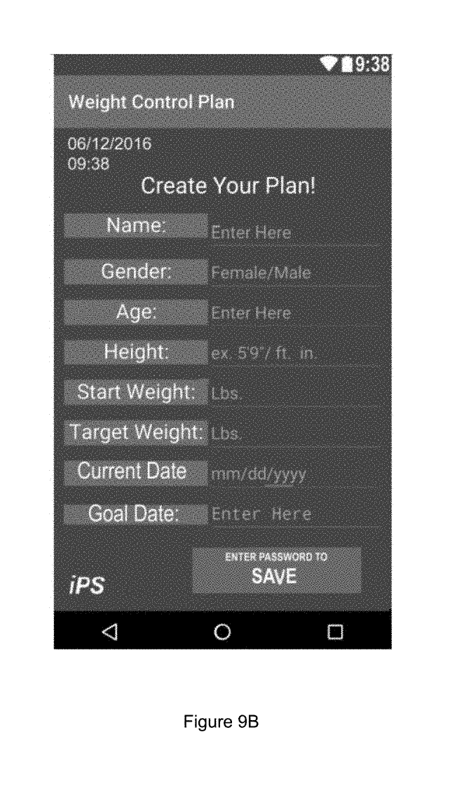

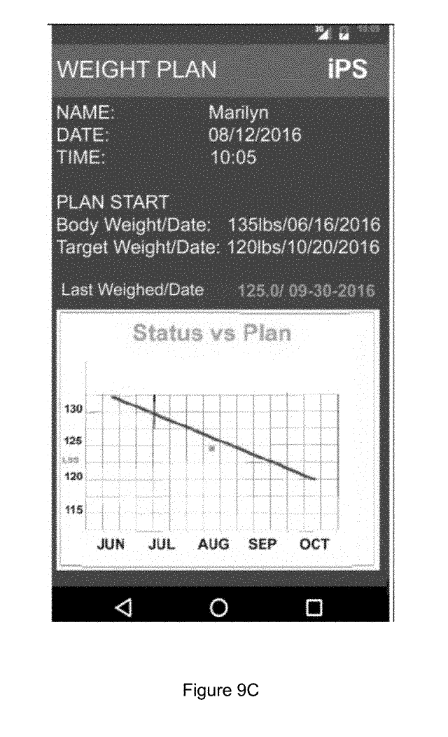

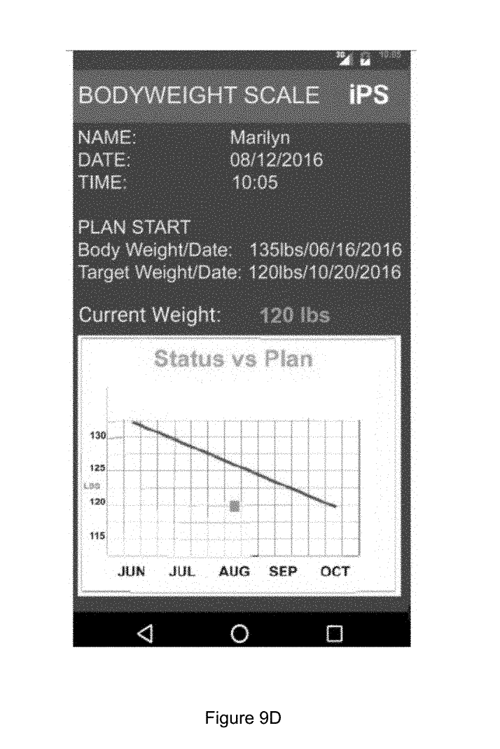

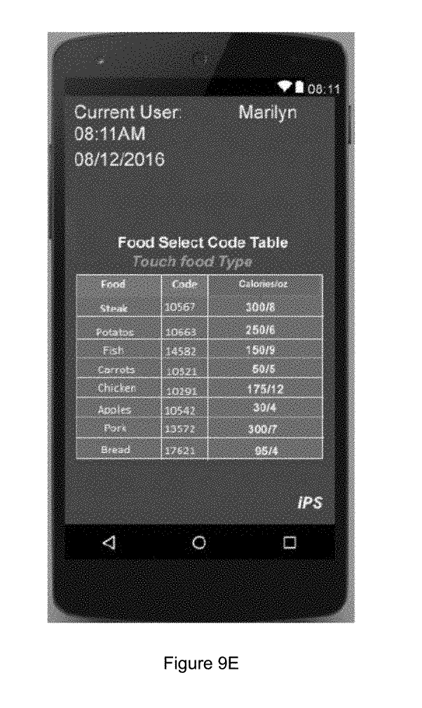

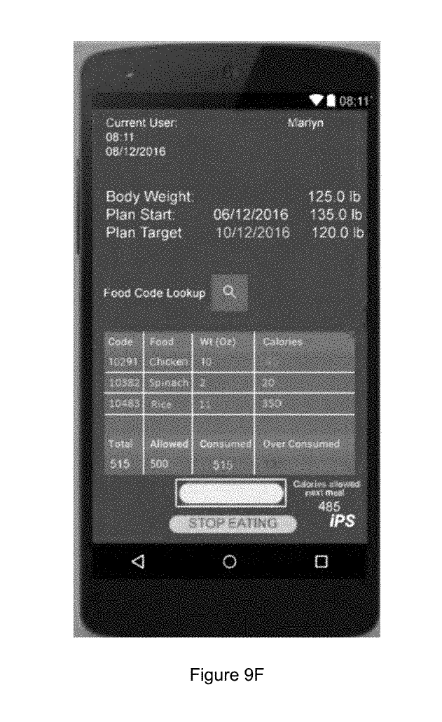

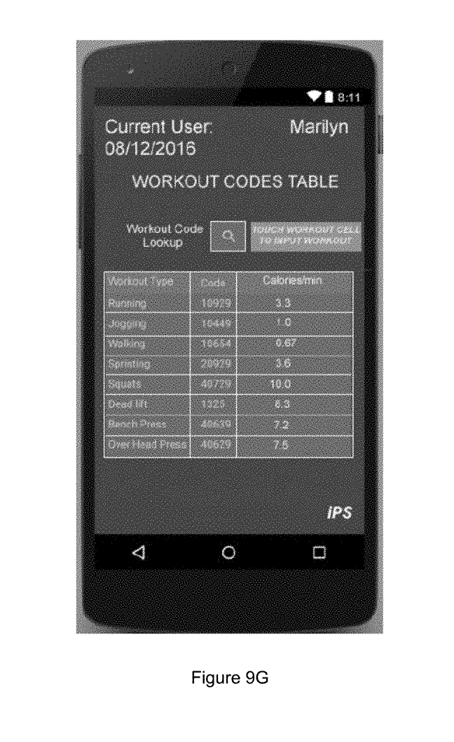

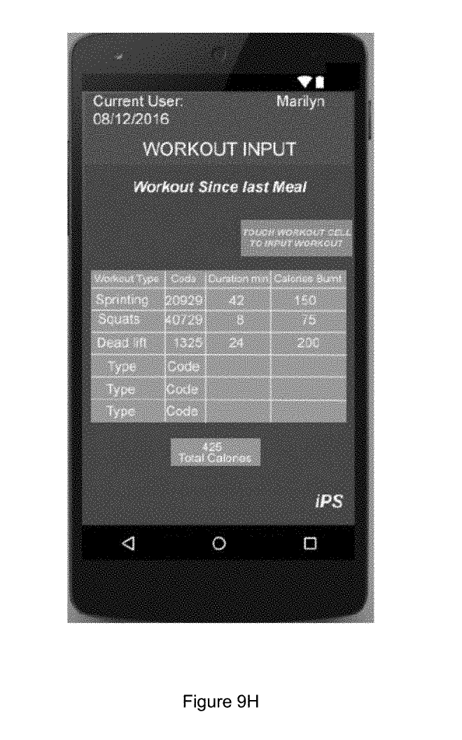

FIGS. 9A through 911 illustrate exemplary screen shots from an Android device running an application for use with a weight control system, in accordance with an embodiment of the present invention. FIG. 9A shows an exemplary welcome page. FIG. 9B shows an exemplary plan creation page. FIG. 9C shows an exemplary status page. FIG. 9D shows another exemplary status page. FIG. 9E shows an exemplary food selection page. FIG. 9F shows an exemplary food weighing page. FIG. 9G shows an exemplary workout selection page, and FIG. 911 shows an exemplary workout input page. These screen shots depict a progression of what may be displayed on a user's device when using the weight control application. In typical use of the present embodiment, the user has access to any part of the application by simply touching the cell on the display screen. The application software automatically populates the assigned data to various screens connected via Bluetooth wireless or USB wire connection to receive and display the data.

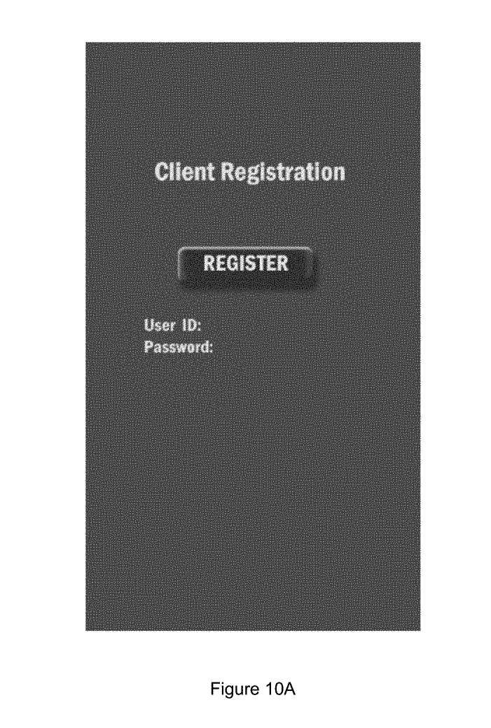

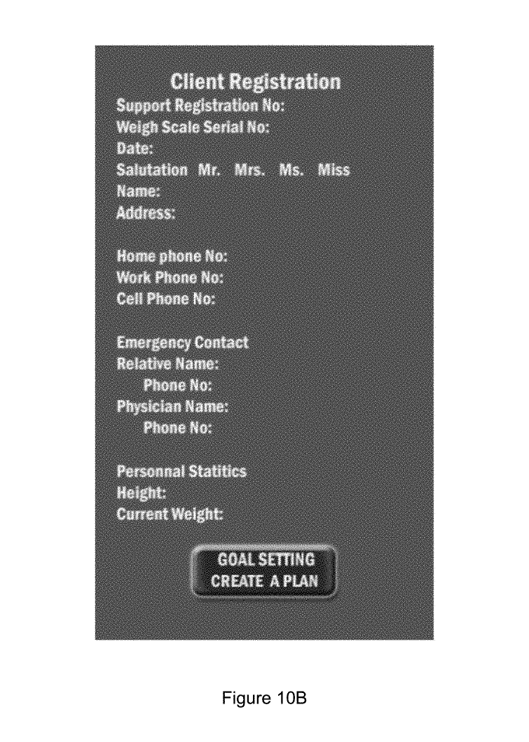

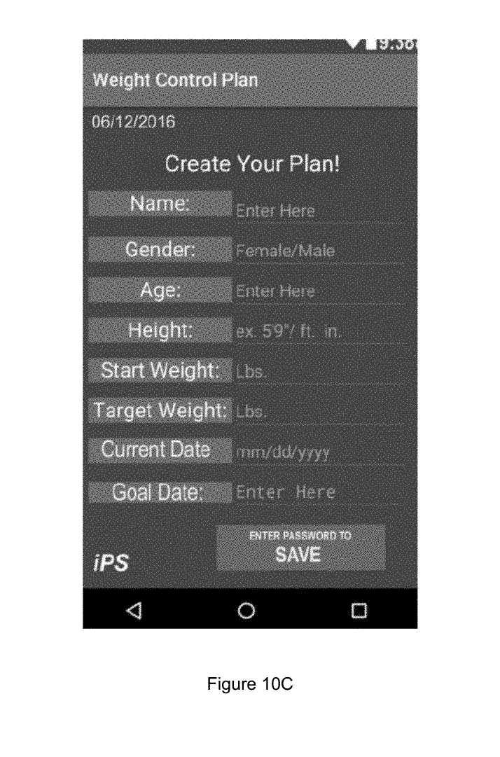

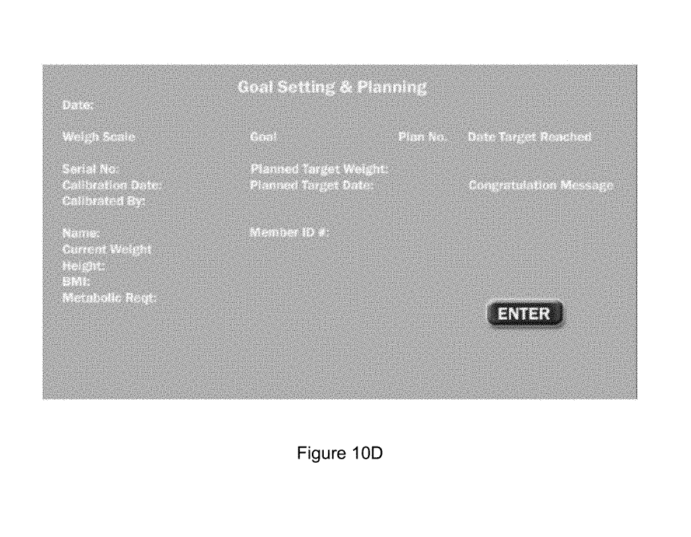

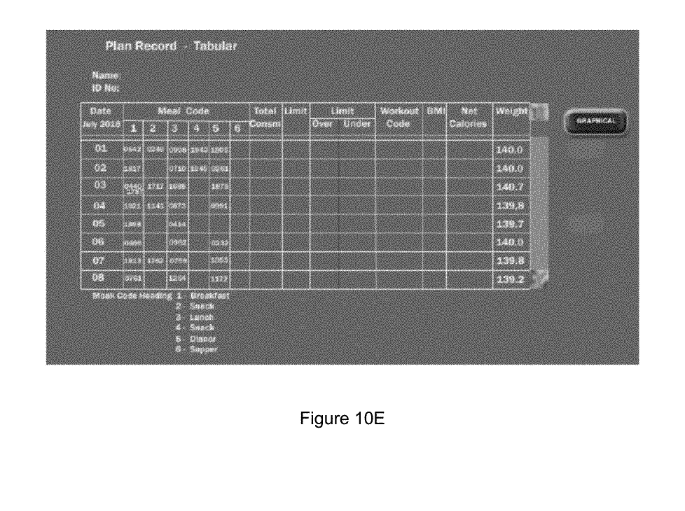

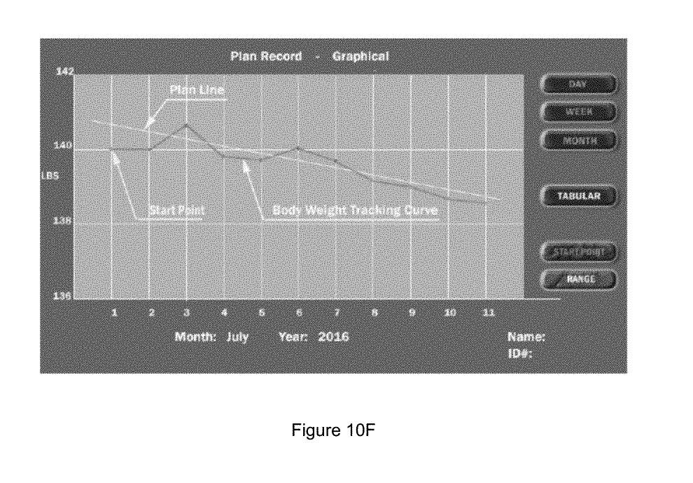

FIGS. 10A through 10F illustrate exemplary screen shots from an IOS® device running an application for use with a weight control system, in accordance with an embodiment of the present invention. FIG. 10A shows an exemplary welcome page. FIG. 10B shows an exemplary client registration page. FIG. 10C shows an exemplary plan creation page. FIG. 10D shows an exemplary goal setting page. FIG. 10E shows an exemplary plan record in a tabular format, and FIG. 10F shows an exemplary plan record in a graphical format. In the present embodiment, the user has access to any part of the application by simply touching the cell on the display screen. The application software automatically populates the assigned data to various screens connected via Bluetooth wireless or USB wire connection to receive and display the data.

It is contemplated that in some embodiments a dual function scale may be implemented by configuring weighing mechanisms in ways other than back to back. For example, without limitation, some embodiments may mount the weighing mechanisms side by side, one on top the other, or one nested inside the other as illustrated by way of example in FIG. 6. Furthermore, scales with dual functionality may be used in applications other than weight control such as, but not limited to, for weighing ingredients, particularly in restaurants where users may benefit from being able to weigh large and small quantities with a single scale, or for weighing mail using the food side to weigh letters and small packages and the body side to weigh large packages. In addition, scales with dual function capability contained in one package may be used for weighing commodities of value such as, but not limited to, gold where the weight accuracy down to grams may be required and commodities of less value that may call for less accuracy in their weighing.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112(1), all claims must be supported by sufficient disclosure in the present patent specification, and any material known to those skilled in the art need not be explicitly disclosed. However, 35 USC § 112(6) requires that structures corresponding to functional limitations interpreted under 35 USC § 112(6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) when such corresponding structures are not explicitly disclosed in the foregoing patent specification. Therefore, for any invention element(s)/structure(s) corresponding to functional claim limitation(s), in the below claims interpreted under 35 USC § 112(6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112(6). Applicant(s) note that all the identified documents above which are incorporated by reference to satisfy 35 USC § 112(6) necessarily have a filing and/or publication date prior to that of the instant application, and thus are valid prior documents to incorporated by reference in the instant application.

Having fully described at least one embodiment of the present invention, other equivalent or alternative methods of implementing a dual function scale according to the present invention will be apparent to those skilled in the art. Various aspects of the invention have been described above by way of illustration, and the specific embodiments disclosed are not intended to limit the invention to the particular forms disclosed. The particular implementation of the dual function scale may vary depending upon the particular context or application. By way of example, and not limitation to scales described in the foregoing were principally directed to portable implementations; however, similar techniques may instead be applied to stationary scales that may benefit from the ability to measure two separate weight ranges, for example, without limitation, in a doctor's office where one side may be used to weigh small children and the other side may be used to weigh larger children and adults or in a veterinarian's office where one side may be used to weigh larger dogs and cats while the other side may be used to weigh small animals such as, but not limited to small dogs and cats, hamsters, reptiles, ferrets, etc., which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A system comprising:
a weighing scale device, in which said weighing scale device comprising, at least;
a first weighing scale apparatus, wherein said first weighing scale apparatus is configured to measure a body weight when said first weighing scale is facing upward;
a second weighing scale apparatus, wherein said second weighing scale apparatus is configured to measure an amount of food when said second weighing scale apparatus is facing upward and said first weighing scale apparatus is facing downward; and
wherein said second weighing scale apparatus is disposed on a flipside of said first weighing scale apparatus to form a dual weighing scale device; and
a platform device, wherein said platform device is configured to perform a weight control function, in which said platform device comprising, at least;
a user interface comprising a display configured to display and accept information, said user interface further comprising at least an action button that is configured to indicate whether body or food is to be weighed, and a comment section that is configured to display a preset notification of a status of said weighing scale device.

2. The system of claim 1, wherein said first weighing scale apparatus is a body weighing scale apparatus and said second weighing scale apparatus is a food weighing scale apparatus.

3. The system of claim 2, wherein said second weighing scale apparatus is disposed on a proximate back side of said first weighing scale apparatus.

4. The system of claim 3, further comprising a base plate structure.

5. The system of claim 4, further comprising a foot step plate labeled with FOOD or Food Wt.

6. The system of claim 5, further comprising a body weight load cell disposed proximately between said base plate and said foot step plate, wherein said body weight load cell has a low sensitivity operable for measuring body weight.

7. The system of claim 6, further comprising a food weighing tray labeled with BODY or Body Wt.

8. The system of claim 7, further comprising a food weight load cell disposed proximately between said base plate and said food weighing tray, wherein said food weight load cell has a high sensitivity operable for measuring an amount of food.

9. The system of claim 8, wherein said first weighing scale apparatus operates independently from said second weighing scale apparatus.

10. The system of claim 9, wherein said first weighing scale apparatus is configured to measure a maximum of approximately 300 pounds, and wherein said second weighing scale apparatus is configured to measure a maximum of approximately 10 pounds.

11. The system of claim 4, in which said base plate at least comprises an electronics compartment section and a battery compartment section.

12. The system of claim 11, further comprising at least a USB port configured to connect said weighing scale to said platform device or to charge batteries in battery compartment section.

13. The system of claim 12, further comprising a load sensitive beam and a wireless circuitry configured to communicate with said platform device.

14. The system of claim 7, further comprising a foot step plate cover structure configured to safeguard said foot step plate.

15. The system of claim 14, further comprising a food weighing tray cover structure configured to safeguard said food weighing tray.

16. The system of claim 15, wherein said foot step plate cover structure and said food weighing tray cover structure are configured to hold approximately 300 pounds.

17. A system comprising:
means for measuring a body weight when said body weight measuring means is facing upward;
means for measuring an amount of food when said food measuring means is facing upward and said first weighing scale apparatus is facing downward;
wherein said food measuring means is disposed proximate on a flipside of said body weight measuring means to form a dual function scale device;
wherein said food measuring means and said weight measuring means operates independently from each other;
means for forming a load measuring surface, wherein said load measuring surface means comprising of means for forming a body weight measuring surface and means for forming a food weight measuring surface;
means for displaying and accepting information; and
means for connecting said dual function scale device and said information displaying and accepting means.

18. The system of claim 17, means for covering said load measuring surface means.

19. A system comprising:
a weighing scale device, in which said weighing scale device comprising, at least;
a first weighing scale apparatus, wherein said first weighing scale apparatus is configured to measure a body weight when said first weighing scale is facing upward;
a second weighing scale apparatus, wherein said second weighing scale apparatus is configured to measure an amount of food when said second weighing scale apparatus is facing upward and said first weighing scale apparatus is facing downward;
wherein said second weighing scale apparatus is disposed on a proximate flipside of said first weighing scale apparatus to form a dual weighing scale device; and
wherein said first and second weighing scale apparatus operates independently from each other; and
a platform device, wherein said platform device is configured to perform a weight control function, in which said platform device comprising, at least;
a user interface comprising a display configured to display and accept information, said user interface further comprising at least an action button that is configured to indicate whether body or food is to be weighed, and a comment section that is configured to display a preset alert notification of a status of said weighing scale device; and
an electronic circuitry operable for communicatively coupling said weighing scale device and said platform device.

20. The system of claim 19, further comprising;
a body weight load cell disposed proximately between a base plate and a foot step plate of said first weighing scale apparatus, in which said body weight load cell comprises at least four load cells mounted on a first side of said base plate, wherein said body weight load cell is operable for measuring body weight; and
a food weight load cell disposed proximately between said base plate and a food weighing tray of said second weighing scale apparatus, in which said food weight load cell comprises at least four food weight load cells mounted on a second side of said base plate opposite to said first side, wherein said food weight load cell is operable for measuring an amount of food.
